(19) United States
(12) Patent Application Publication
(10) Pub. No.: US 2023/0347689 A1
(43) Pub. Date: Nov. 2, 2023

(54) TRANSPORTATION ASSEMBLY AND INTERFACE DEVICE

(71) Applicant: WHEEL.ME AS, Oslo (NO)

(72) Inventors: Atle TIMENES, Snarøya (NO); Dan Henriksen, Båtsfjord (NO)

(21) Appl. No.: 18/025,744

(22) PCT Filed: Sep. 17, 2021
(86) PCT No.: PCT/EP2021/075647

§ 371 Date: Mar. 10, 2023

(30) Foreign Application Priority Data
Sep. 18, 2020 (NO) 20201025

(51) Int. Cl. B60B 33/06; B60B 33/00; B60B 19/00

(52) U.S. Cl. CPC B60B 33/06; B60B 33/0002; B60B 19/003; B62B 3/00

(57) ABSTRACT

A transportation assembly for transportation of an object on a surface comprises at least four rolling devices, a transportation body and at least one interface element for each rolling device. The interface element is adapted for connecting the rolling device to the transportation body. The interface element for mounting or integration of a rolling device to/into an object comprises an upper part and a lower part, where the upper part and the lower part comprise complimentary shaped guiding means.

The present invention concerns a transportation assembly for transportation of an object on a surface. The transportation assembly comprises interface devices adapted for connecting the rolling device to the transportation body.

The transportation assembly may be suitable for mounting or integration to/into the object for enabling the movement of the object along a surface, or the transportation assembly may be a separate device for transportation of objects.

The invention is suitable for moving all kind of objects that is to be moved between different locations both indoors and outdoors, where the movement is to occur along a surface, for instance a floor.

### BACKGROUND

There are a number of circumstances where there is a need for moving various devices, such as and especially furniture, may be provided with wheels or roller elements for facilitating the movement of devices from one location to another, for instance for regrouping devices or moving a device to get access to the space the device occupies or to provide access to the device itself.

The applicant has previously developed a rolling device capable of being integrated in devices, such as a piece of furniture, a movable wall etc., for moving the device along a surface. The rolling device facilitates the moving of an object and can be used by everyone regardless of physical condition and capacity to lift different devices in which the rolling device is integrated. This device is described in Norwegian Patent NO 316760 B 1.

The rolling device of NO 316760 B 1 comprises a cylindrical sleeve device for mounting in, for example, the leg of a piece of furniture, and a piston that is movably arranged in the cylindrical sleeve device. A ball-shaped or spherical wheel is arranged in the piston. The piston is movable, with the aid of a click system comprising a spring, between an upper position and a lower position. When the piston is in the lower position, the piece of furniture can be rolled across the floor it is standing on, whilst when the piston is in the upper position, the wheel is inside the cylindrical sleeve device and the leg of the piece of furniture, in which the rolling device is arranged, thus stands on the floor. The piece of furniture thus stands in the desired position without rolling inadvertently across the floor when small forces are applied to the piece of furniture. The solution is completely mechanical.

The applicant has further developed the concept and provided a rolling device with an automatic actuator system for moving a piston with a rolling element between an upper and lower position. This concept is disclosed in EP 3102429. The upper position is a passive stationary position where the wheel element is retracted in the rolling device, and the lower position is an active position for moving the rolling device along a surface. The actuator can be wirelessly controlled.

In a further version as described in WO 2018138320, the applicant has evolved the concept of the rolling device further. WO 2018138320 presents a rolling device for arrangement for autonomously moving a device from a first position to a second position along a surface. The rolling device controls the movements of a rolling element according to position acquisitions and given position and movement instructions. The rolling element may have a set or fixed vertical position relative to the rolling device or may be arranged for displacement between a retracted position where the wheel element is prevented from moving along a surface and an extended position where the wheel element is prepared for movement along the surface, as described in EP 3102429 and NO 316760 B 1.

The object of the invention is to provide transportation means which can be used for a variety of objects, which is easy to adapt to the specific need.

A further object of the invention is to provide a transportation assembly for transportation of an object on a surface and an interface element for mounting or integration to/into an object that provides flexible transportation of various objects.

The object of the invention is achieved by means of the features of the patent claims.

### SUMMARY OF THE INVENTION

A transportation assembly for transportation of an object on a surface comprises in one embodiment at least four rolling devices, a transportation body and at least one interface element for each rolling device, where the interface element is adapted for connecting the rolling device to the transportation body.

As described above, the transportation assembly may be an independent device which can transport any object by moving the transportation body to under the object arranged on a surface, lift the object from the surface and move it along the surface.

The transportation body may comprise elongated profiles having two ends, where each end comprises attachment means adapted to be connected to the interface element. The transportation body can in one embodiment comprise corner elements adapted to be connected to the ends of the elongated profiles. The elongated elements and the corner elements may be assembled to form a frame. In this embodiment, the interface elements connect the rolling devices to the frame.

The length and size of the elongated profiles may vary according to the intended use of the transportation assembly. Similarly, the number of rolling devices may be more than four in order to be able to transport larger and/or heavier objects.

The transportation assembly may further comprise at least one height element adapted to be arranged between the rolling device and the transportation body in order to adapt the height of the transportation assembly to the object to be transported.

There may also be embodiments where the transportation assembly is integrated in the object itself, in which case the object itself is comprised in the transportation body or constitutes the transportation body.

The interface element can thus convert any transportation body to be a part of a transportation assembly.

In one configuration the interface elements comprise an upper part and a lower part. The upper part may comprise rolling device fastening means for connecting to the rolling device and the lower part may comprise an object fastening means for connecting to the object.

The interface elements may further comprise locking means for locking the upper part to the lower part, and thus in one configuration the rolling device fastening means to the object fastening means.

In one embodiment, the interface element and the transportation body comprise complimentary shaped guiding means. The interface element and the corner elements may comprise complimentary shaped guiding means.

In one embodiment, the rolling device comprises a cylinder with an opening at one end thereof and a piston that is arranged reciprocally movably in the cylinder such that the piston can be moved between an upper position in the cylinder and a lower position in the cylinder, which piston comprises a rolling element that is arranged at a first end portion of the piston facing the cylinder opening and that rolls on a surface when the device is to be moved, which rolling device further comprises an actuator system for moving the piston between the upper position and the lower position in the cylinder.

One example of a wheel for use with the rolling device is a Mecanum wheel. The Mecanum wheel has a configuration allowing movement in any direction, and it is a conventional wheel with a series of rollers attached to its circumference. These rollers may typically each have an axis of rotation at 45° to the plane of the wheel and at 45° to a line through the centre of the roller parallel to the axis of rotation of the wheel but may of course also be arranged with axis of rotation having other inclinations than 45°.

In one embodiment the transportation assembly further comprises at least one height element adapted to be arranged between the rolling device and the transportation body.

### BRIEF DESCRIPTION OF THE DRAWINGS

The invention will now be described in more detail by reference to the accompanying figures.

FIGS. 1 and 2 shows an example of a transportation assembly with six wheels for transportation of an object on a surface.

FIGS. 3a and 3b illustrates schematically an interface element for use in a transportation assembly.

FIG. 4 illustrates a corner element comprised in an embodiment of a transportation assembly.

FIGS. 5a and 5b illustrates two examples of interface elements.

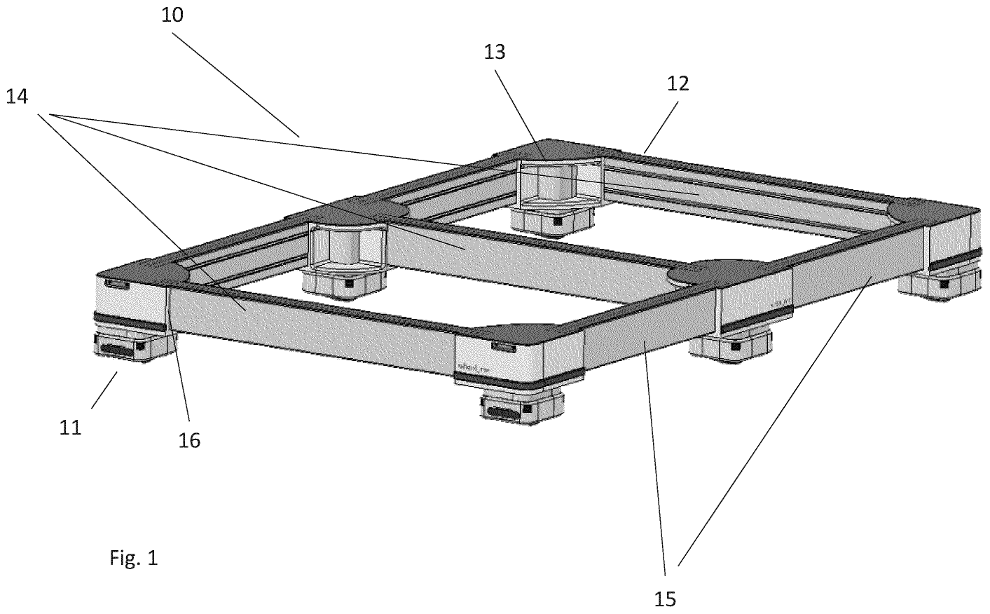

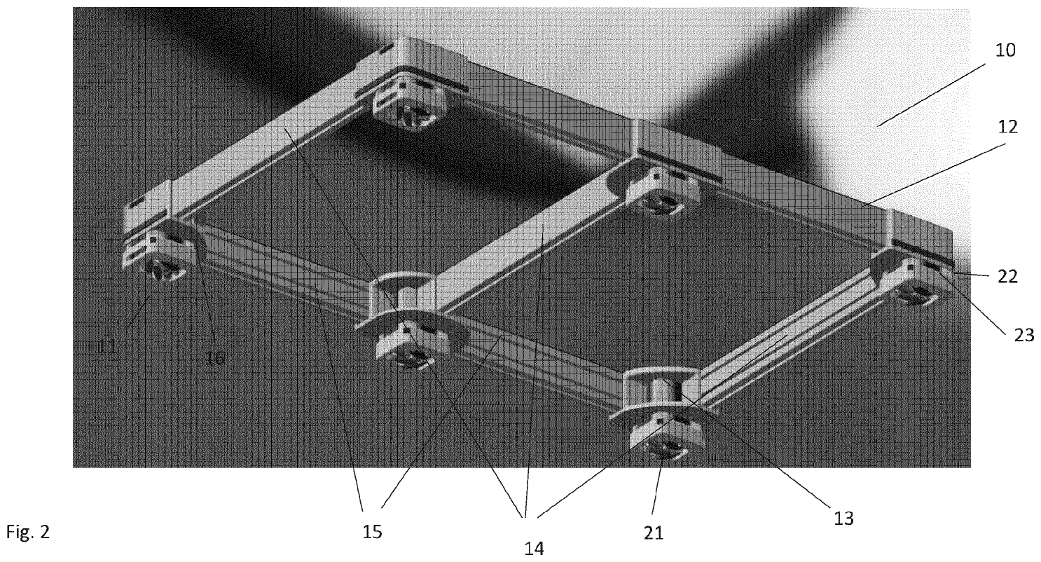

FIGS. 1 and 2 shows an example of a transportation assembly 10 for transportation of an object on a surface. The transportation assembly 10 comprises in this example six rolling devices 11, a transportation body 12, and interface elements 13 for connecting the rolling devices 11 to the transportation body 12. As described above, the number of rolling devices may be adapted to the intended use. Higher number of rolling devices may be used in order to be able to transport more weight or larger objects.

The transportation body 12 comprises in this example elongated profiles 14, 15, each having two ends, where each end comprises attachment means 16 adapted to be connected to the interface element.

In this embodiment the attachment means 16 are corner elements adapted to be connected to the ends of the elongated profiles. The corner elements will be described in more detail below.

The elongated profiles 14, 15 and the corner elements 16 form together a frame, which in this embodiment is the transportation body which can support the object to be transported during transportation.

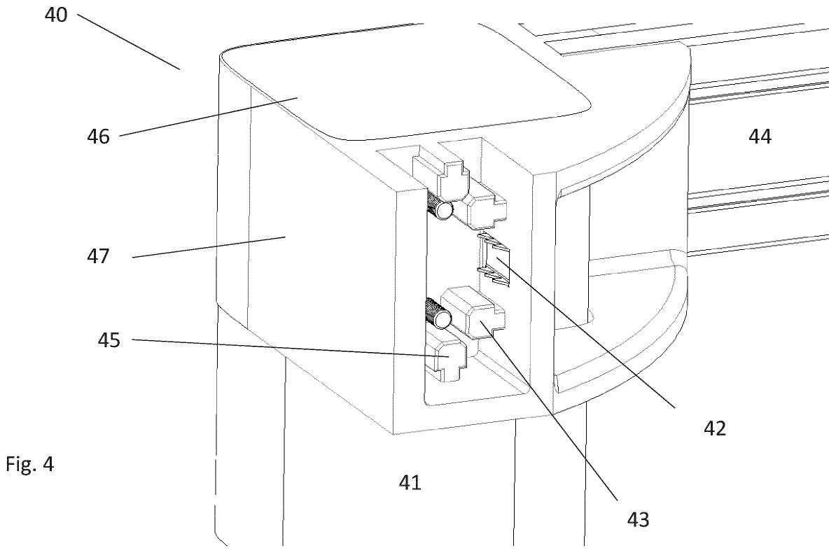

FIG. 4 illustrates a corner element 40 comprised in an embodiment of a transportation assembly, for example the corner element 16 connecting the elongated elements illustrated in FIGS. 1 and 2.

The corner element 40 is part of the transportation body and comprises or is connected to the interface element. The corner element 40 comprises a housing 47, an interface element 46 and connecting means for receiving and securely connecting to the attachment means 42, 43, 45 of the elongated profiles 41, 44. The connecting means are complimentary shaped with the attachment means of the elongated profiles 41, 44, or other elements comprised in the transportation body.

The rolling devices 11 comprise each a rolling element or wheel 21. The rolling device 11 as shown in FIGS. 1 and 2 is arranged with a housing and is provided with the rolling element 21 arranged at a one end of the housing. The rolling element is to engage the surface when the moving of the device is to be carried out.

In the example in FIG. 2, the rolling devices comprises mecanum wheels that allows the transportation assembly to move in any direction, but it will be clear that other types of rolling devices may be used.

The rolling device may further comprise a cylinder 22 with an opening at one end and a piston 23 that is arranged reciprocally movably in the cylinder 22 such that the piston can be moved between an upper position in the cylinder and a lower position in the cylinder. The piston comprises or is connected to the rolling element 21 that is arranged at a first end portion of the piston facing the cylinder opening.

The rolling device 21 further comprises an actuator system for moving the piston between the upper position and the lower position in the cylinder. In this way, the rolling element may be moved between the upper position and the lower position in order to lift or lower the transportation assembly. In the lifted position, the transportation assembly can use the rolling elements 21 to move, while it may be adapted to have a stable position in the lowered position. There may also be positions between the upper and lower position, in order to move the transportation assembly in position under an object to be moved.

The rolling element 21 may be arranged in a set position located at the end of the housing, typically the lower end of the housing when in installed position as connected to the device to be moved. In an alternative version the roller element may be movably arranged in the housing between an upper and lower position. The upper, retracted position is a passive stationary position where the wheel element is retracted in the rolling device, and the lower position is an extracted active position for moving the rolling device along a surface.

Various devices for controlling the rolling element 21 or any other rolling element used in the rolling devices of any embodiment of the invention may be arranged in the housing. There may for example be arranged a wireless receiver and a control device in the housing. The wireless receiver and the control device can be signally connected to each other, and the receiver is arranged for receiving wireless control signals. The rolling device 11 can be arranged with position means for acquiring the position of rolling device 11 relative to its surroundings. The position means can be connected to the control device.

There are different ways of detecting and acquiring the position of the rolling device 11. One example is determining the position from an external device such as a camera or by using Lidar for measuring the distance from a reference point to the rolling device 11. Another example is to use an RFID chip connected to the rolling device 11 or to the device to be moved. Yet another way is by using ultrasound transmitter or a Bluetooth transmitter connected to the rolling device 11 for determining the position of the rolling device 11. Accurate position can then be found by means of triangulation.

The position can then be transmitted to the position means of the rolling device 11. These are all well-known methods and will not be described further here.

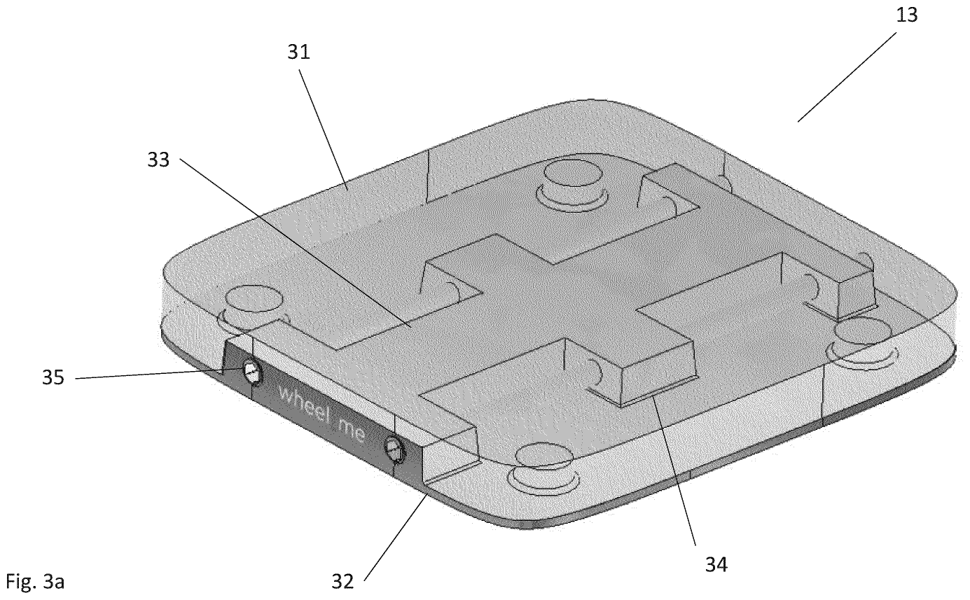

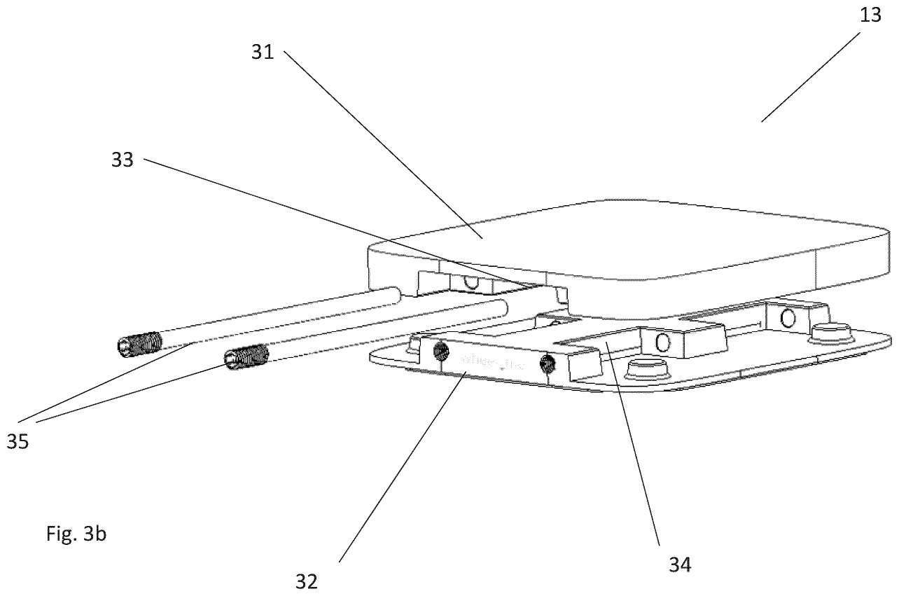

An example of the interface element 13 is illustrated in FIGS. 3a and 3b.

The interface element 13 comprises in this example an upper part 31 and a lower part 32 which comprise complimentary shaped guiding means. 33, 34. This means that the guiding means 33, 35 are shaped such that one protruding guiding part 34 can be inserted into a complimentary shaped guiding recess 33. The complimentary shaped guiding means ensures that the upper and lower parts 31, 32, are correctly positioned when joined, and kept in the correct position during use.

The guiding means 33, 34 may have a tapered form to facilitate the correct positioning.

The interface element 13 further comprise locking elements 35 which locks the upper and lower parts 31, 32 together. In the example of FIGS. 3a and 3b, the locking means are screws that are screwed into corresponding locking holes in the guiding elements.

The transportation assembly illustrated in FIGS. 1 and 2, is configured to be an independent device which can transport an object by moving the transportation body to under the object arranged on a surface, lift the object from the surface and move it along the surface. In this embodiment, the interface elements connect the rolling devices to the frame.

In other embodiments, interface elements are adapted to connect the rolling devices to the object to be transported. The object to be transported is in this example itself the transportation body.

In this latter embodiment, the lower part of the interface element may comprise a rolling device fastening means for connecting to the rolling device, and the upper part of the interface element comprises object fastening means for connecting to the object. The interface elements may be adapted to any possible object to be moved, and provides thus great flexibility of use. The object fastening means can be manufactured by additive manufacturing such as 3D printing, to be specifically adapted to the relevant object. The object fastening means may also be integrated in the object or into a dedicated transportation body.

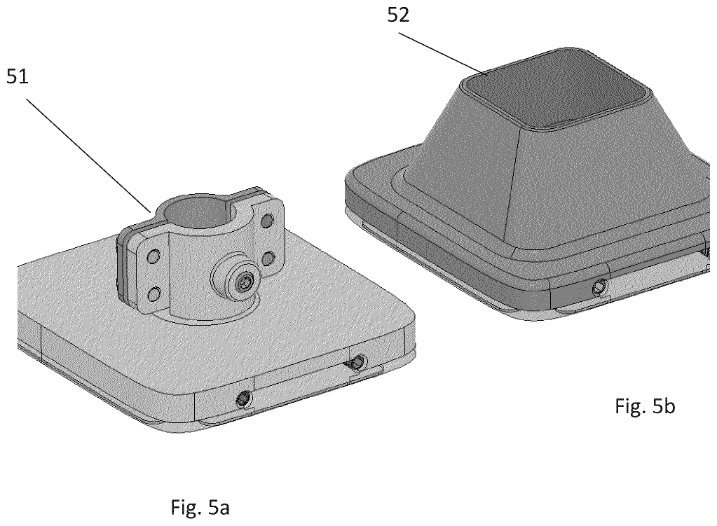

FIGS. 5a and 5b illustrates two examples of interface elements adapted for connecting to an object. FIG. 5a comprises an object fastening means 51 configured to connect to a cylindrical element such as a leg of a table, while FIG. 5b comprises object fastening means 52 configured to another type of object.

1-14. (canceled)

15. A transportation assembly for transportation of an object on a surface, the transportation assembly comprising at least four rolling devices, a transportation body and at least one interface element for each rolling device, where the interface element is adapted for connecting the rolling device to the transportation body, and where the interface element comprises an upper part and a lower part which comprise complimentary shaped guiding means and where the lower part of the interface element comprises rolling device fastening means for connecting to the rolling device and the upper part comprises object fastening means for connecting to the object.

16. Transportation assembly according to claim 15, further comprising at least one height element adapted to be arranged between the rolling device and the transportation body.

17. Transportation assembly according to claim 15, where the transportation body comprises elongated profiles having two ends, where each end comprises attachment means adapted to be connected to the interface element.

18. Transportation assembly according to claim 17, where the transportation body comprises corner elements adapted to be connected to the ends of the elongated profiles.

19. Transportation assembly according to claim 18, where the interface element and the corner elements comprise complimentary shaped guiding means.

20. Transportation assembly according to claim 15, where the rolling device comprises a cylinder with an opening at one end thereof and a piston that is arranged reciprocally movably in the cylinder such that the piston can be moved between an upper position in the cylinder and a lower position in the cylinder, which piston comprises a rolling element that is arranged at a first end portion of the piston facing the cylinder opening and that rolls on a surface when the device is to be moved, which rolling device further comprises an actuator system for moving the piston between the upper position and the lower position in the cylinder.

21. Transportation assembly according to claim 20, where the rolling device comprises Mecanum wheels.

22. Transportation assembly according to claim 15, where the guiding means have a tapered form.

23. The transportation assembly according to claim 15, wherein the rolling device is controlled externally by employing a control device and communicating wireless with the rolling device.

24. The transportation assembly according to claim 23, wherein the control device is arranged within a housing of the corner element.

25. Interface element for mounting or integration of a rolling device to/into an object comprising: an upper part and a lower part, where the upper part and the lower part comprise complimentary shaped guiding means, and where the complimentary shaped guiding means comprises a protruding guiding part and a complimentary shaped guiding recess and wherein the lower part of the interface element comprises a rolling device fastening means for connecting to the rolling device and the upper part comprises object fastening means for connecting to the object.

26. Interface element according to claim 24, where the upper part comprises object fastening means for connecting to the object, and the lower part comprises rolling device fastening means for connecting to the rolling device.

27. Interface element according to claim 24, where the protruding guiding part has inwards slanted side faces, such that the cross section of the protruding parts are smaller at the far end than at the base.

28. Interface element according to claim 24, further comprising locking means for locking the upper part to the lower part.
